(19) United States
(12) Patent Application Publication
(10) Pub. No.: US 2012/0243896 A1
(43) Pub. Date: Sep. 27, 2012

(54) FIXING DEVICE WHICH INCLUDES TEMPERATURE MEASURING UNIT CAPABLE OF MEASURING SURFACE TEMPERATURE OF HEAT APPLYING ROTARY BODY

(75) Inventors: Yutaka Otsuka, Toyokawa-shi (JP); Nobuyasu TAMURA, Toyokawa-shi (JP); Koji TAKAHASHI, Toyokawa-shi (JP)

(73) Assignee: Konica Minolta Business Technologies, Inc., Chiyoda-ku (JP)

(21) Appl. No.: 13/422,540

(22) Filed: Mar. 16, 2012

(30) Foreign Application Priority Data
Mar. 23, 2011 (JP) 2011-063990

(51) Int. Cl. G03G 15/20

(52) U.S. Cl. 399/70

(57) ABSTRACT

A fixing device includes a heating roller which is heated by a heater, a pressure roller which comes into contact with a fixing belt to form a nip portion, and a thermopile capable of measuring a surface temperature of the fixing belt. The fixing device moves that portion on the surface of the fixing belt which was located at the nip portion with the pressure roller at the start of a warm-up operation, to a measurement location of the thermopile. The fixing device uses the thermopile to measure the temperature of that portion on the surface of the fixing belt moved to the measurement location. The fixing device controls the warm-up operation on the basis of the temperature measured by the thermopile. This can reduce the time required for the warm-up operation.

This application is based on Japanese Patent Application No. 2011-63990 filed with the Japan Patent Office on Mar. 23, 2011, the entire content of which is hereby incorporated by reference.

### BACKGROUND OF THE INVENTION

1. Field of the Invention

The present invention relates to fixing devices. More particularly, the present invention relates to a fixing device which includes a temperature measuring unit capable of measuring the temperature of a surface of a heat applying rotary body.

2. Description of the Related Art

Electrophotographic image forming devices include a facsimile machine, a copier, a printer, and a multi-function peripheral (MFP) provided with the scanner function, facsimile function, copying function, function as a printer, data communicating function, and server function.

An image forming device generally forms a toner image on an image carrier using a developing roller, transfers the toner image formed on the image carrier onto a sheet of paper (transfer material), and then heats the toner image using a fixing device (fuser) to fuse it on the sheet, thereby forming an image on the sheet.

In order to reduce the electric power consumed by the image forming device, during a standby period of the image forming device, the fixing device is kept at a certain temperature that is lower than a temperature (hereinafter, referred to as a “fixable temperature”) at which the fixing device is capable of fixing a toner image. During the use of the image forming device, a heating roller is heated so as to raise the temperature of the fixing device to the fixable temperature.

An operation of returning an image forming device to a state where the device can perform printing is called “warm-up” (or a “warm-up operation”). In the warm-up operation, heat [J=W·s] of an amount that is necessary to impart a prescribed fix level to a toner image is input to components of the fixing device, so that the temperature of the fixing device is raised to the fixable temperature. The amounts of heat required to be input to the respective components of the fixing device depend on the amount of heat (storage of heat) that the fixing device retains at the start of the warm-up operation. Therefore, an optimal way of starting the image forming device varies in accordance with the state of the image forming device at the start of the warm-up operation.

The state of the image forming device may be detected by measuring the temperature of the fixing device. According to this method, the amount of heat [J] retained in the fixing device is computed on the basis of the heat capacity [J/K] of the fixing device, which is known in advance, and the temperature [K] of the fixing device. As it is not possible to measure the temperatures of all the components of the fixing device, according to this method, the temperature of a representative component is measured and, on the basis of the measured temperature, the amount of heat [J] retained in the fixing device is computed approximately. In this method, in order to more accurately compute the amount of heat [J] retained in the fixing device, it is preferable to measure the temperature [K] of a component having large heat capacity [J/K]. Conventionally, as such a component with large heat capacity [J/K], the temperature of a pressure roller has been measured directly.

Documents 1 to 3 listed below each disclose a conventional method for controlling a fixing device. In a color laser printer disclosed in Document 1 below, during warm-up processing, a pressure roller and a heating roller are rotated in a direction opposite from the paper transport direction, so as to remove waste toner and paper dust from the portion where a temperature sensor is in contact with the heating roller.

In a fixing control device disclosed in Document 2 below, in the case where a high-temperature state of a fixing belt is detected at a position where a thermistor is arranged, the fixing belt is forcibly rotated in an opposite direction, and the temperature of the fixing belt at the portion corresponding to the fixing nip portion is sensed again with the thermistor, to thereby determine whether the fixing device is in a state of abnormal temperature.

In a fixing device disclosed in Document 3 below, full electric power is supplied during a temperature regulating period at startup, and the temperature rise time of a fixing heater is measured from the temperature sensed by a sub-thermistor, to predict the maximum electric power to be supplied to the fixing device.

### [Document 1] Japanese Patent Application Laid-Open No. 2005-338314

### [Document 2] Japanese Patent Application Laid-Open No. 2005-91890

### [Document 3] Japanese Patent Application Laid-Open No. 2004-191966

With the conventional methods described above, however, when an image forming device (system) does not have a temperature detecting device for a pressure roller, it is not possible to directly measure the temperature of the pressure roller, hindering accurate computation of the amount of heat being retained by the fixing device. Further, even in the case of an image forming device that can directly measure the temperature of the pressure roller, the temperature being measured is a surface temperature of the pressure roller, which does not accurately represent the amount of heat being retained inside the pressure roller. This causes an increase in user's wait time and/or wasting of electric power due to the warm-up operation. Furthermore, if the computed amount of heat being retained in the fixing device is greater than the actual amount, the amount of heat input to the fixing device may be inadequate, leading to poor image fixing performance. None of the techniques described in Documents 1 to 3 can solve these problems.

### SUMMARY OF THE INVENTION

In view of the foregoing, an object of the present invention is to provide a fixing device which can reduce time necessary for a warm-up operation.

Another object of the present invention is to provide a fixing device, an image forming device which can reduce power consumption.

An aspect of the present invention provides a fixing device having a heat applying rotary body heated by a heat source, a pressure applying rotary body which comes into contact with the heat applying rotary body to form a nip portion, and a temperature measuring unit capable of measuring a temperature of a surface of the heat applying rotary body, wherein the fixing device includes: a moving unit operable to move that portion on the surface of the heat applying rotary body which was located at the nip portion at the start of a warm-up operation to a measurement location of the temperature measuring unit, the warm-up operation being an operation of bringing surfaces of the heat applying rotary body and the pressure applying rotary body to a temperature at which printing is possible; a first temperature measuring unit that uses the temperature measuring unit to measure a temperature of that portion on the surface of the heat applying rotary body moved to the measurement location by the moving unit; and a warm-up control unit that controls the warm-up operation on the basis of the temperature measured by the first temperature measuring unit.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 is a cross sectional view showing the configuration of a color printer to which a fixing device according to an embodiment of the present invention is adapted;

FIG. 2 is a cross sectional view schematically showing a configuration of the fixing device shown in FIG. 1;

FIG. 3 is a cross sectional view schematically showing another configuration of the fixing device shown in FIG. 1;

FIG. 4 is a block diagram showing the configuration of the color printer according to an embodiment of the present invention;

FIG. 5 shows changes over time of the temperatures of a heating roller and a pressure roller in the case where a heater in a target temperature state is turned off while the pressure roller is at a low temperature;

FIG. 6 shows changes over time of the temperatures of the heating roller and the pressure roller in the case where the heater in the target temperature state is turned off while the pressure roller is at a high temperature;

FIG. 7 is a flowchart illustrating a warm-up operation of the fixing device;

FIG. 8 illustrates a subroutine of the processing in step S11 in FIG. 7 in the case where a first setting method is employed;

FIG. 9 is a flowchart illustrating a counting method of the fixing device which is carried out in a second setting method;

FIG. 10 shows, by way of example, an evaluation table used in the second setting method;

FIG. 11 illustrates a subroutine of the processing in step S11 in FIG. 7 in the case where the second setting method is employed;

FIG. 12 schematically shows changes over time of the temperature of the pressure roller during the warm-up operation in the case where the pressure roller (the fixing device) is not warm; and

FIG. 13 schematically shows changes over time of the temperature of the pressure roller during the warm-up operation in the case where the pressure roller (the fixing device) is warm.

### DESCRIPTION OF THE PREFERRED EMBODIMENTS

A preferred embodiment of the present invention will be described below with reference to the accompanying drawings.

### [Configurations of Image Forming Device and Fixing Device]

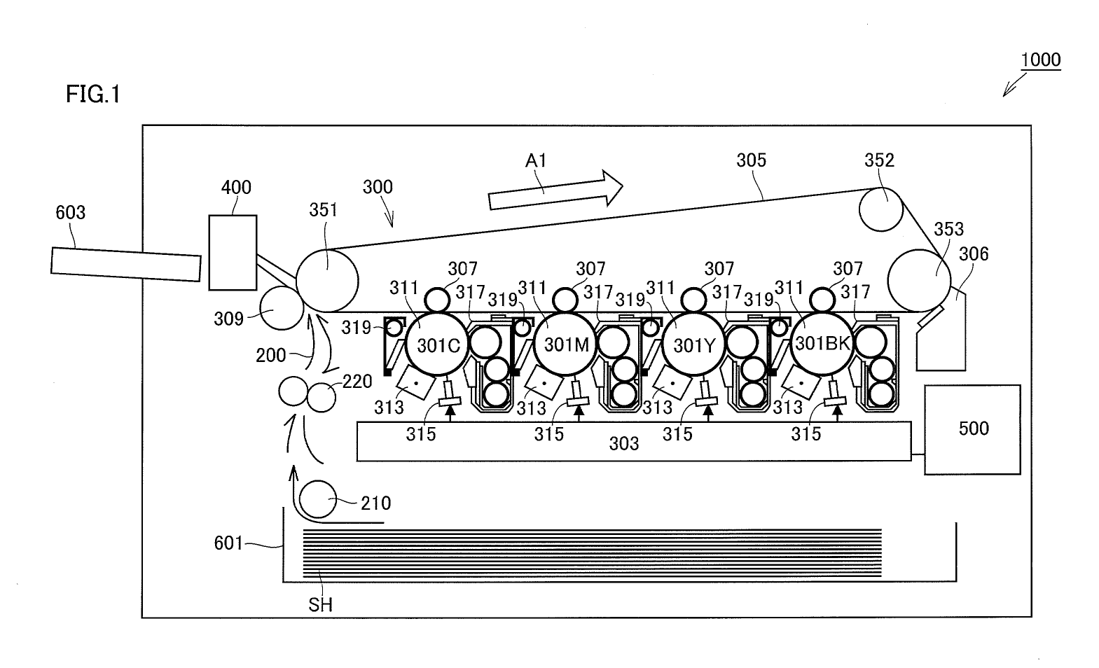

While a color printer is described as the image forming device in the present embodiment, the fixing device of the present invention may be adapted, not only to the color printer shown in FIG. 1, but also to another image forming device such as a monochrome/color copier, printer, facsimile machine, or composite machine thereof.

Referring to FIG. 1, a color printer 1000 as the image forming device according to the present embodiment primarily includes a paper transport unit 200, a toner image forming unit 300, a fixing device 400, and a control unit 500.

Paper transport unit 200, toner image forming unit 300, and fixing device 400 combine images of four colors of black (BK), yellow (Y), magenta (M), and cyan (C) as required, using a so-called tandem system, to form a color image on a sheet of paper.

Paper transport unit 200 is configured to feed a sheet SH of paper (recording paper) set in a paper cassette 601 (recording paper cassette) to toner image forming unit 300 and fixing device 400, and discharge a sheet on which an image has been formed to a catch tray 603. Paper cassette 601 is disposed in the lower part in FIG. 1 of the housing of color printer 1000, and is removable from the housing. Catch tray 603 is arranged at the upper left part in FIG. 1 of the housing of color printer 1000. A sheet SH set in paper cassette 601 is transported upward in FIG. 1 to toner image forming unit 300, where a toner image is formed thereon. The sheet SH is then transported leftward in FIG. 1, via fixing device 400, and is discharged to catch tray 603.

Paper transport unit 200 includes a feed roller 210 and a transport roller 220. In each of feed roller 210 and transport roller 220, two opposite rollers, for example, that sandwich a sheet therebetween are rotated to thereby transport the sheet. During printing, feed roller 210 feeds sheets SH, loaded in paper cassette 601, one by one, into the interior of the housing of color printer 1000. Transport roller 220 transports the sheet fed by feed roller 210 to toner image forming unit 300. It is noted that, besides the above-described rollers, paper transport unit 200 may include, for example, a discharge roller for discharging the sheet that has passed through fixing device 400 to catch tray 603, and other rollers for use in transporting a sheet.

Toner image forming unit 300 includes: image forming units 301BK, 301Y, 301M, and 301C (hereinafter, they may also be collectively referred to as “image forming units 301”), an exposure controller 303, an intermediate transfer belt 305, four primary transfer rollers 307, and a secondary transfer roller 309. Image forming units 301BK, 301Y, 301M, and 301C are arranged at the center inside the housing of color printer 1000, side by side in this order from the upstream side to the downstream side of the running direction (indicated by an arrow A1) of intermediate transfer belt 305. Exposure controller 303 is arranged beneath image forming units 301BK, 301Y, 301M, and 301C, and intermediate transfer belt 305 is arranged above image forming units 301BK, 301Y, 301M, and 301C. Four primary transfer rollers 307 are arranged corresponding respectively to image forming units 301BK, 301Y, 301M, and 301C. Secondary transfer roller 309 is arranged in the vicinity of the paper transport path of paper transport unit 200.

Image forming units 301 each include: a photoreceptor drum 311 which rotates; an electrifying device 313 for uniformly electrifying photoreceptor drum 311; an exposure unit 315 which uses a laser beam to expose an image onto the electrified photoreceptor drum 311; a development device 317 which forms a toner image by developing the static latent image formed by exposure with toner of the corresponding color; and a cleaning blade 319 which removes and collects toner remaining on photoreceptor drum 311 after the primary transfer.

Exposure controller 303 is located so that it can scan each photoreceptor drum 311 with a laser beam via the corresponding exposure unit 315. Exposure controller 303 drives one or more exposure units 315 in accordance with the corresponding colors.

Intermediate transfer belt 305 forms a loop and is laid around, for example, three rollers 351 to 353. Intermediate transfer belt 305 is rotated in a synchronized manner with paper transport unit 200 to travel in the direction shown by the arrow A1. Secondary transfer roller 309 is arranged to face that portion of intermediate transfer belt 305 which is in contact with roller 351. The distance between secondary transfer roller 309 and intermediate transfer belt 305 is adjusted by a pressing/separating mechanism.

A toner image developed on photoreceptor drum 311 is transferred onto intermediate transfer belt 305 by primary transfer roller 307 at the position of contact with intermediate transfer belt 305. As intermediate transfer belt 305 passes through image forming units 301, the toner images of the respective colors are transferred onto intermediate transfer belt 305 so that they are superposed on one another, and finally, a full color toner image is formed on intermediate transfer belt 305. Paper transport unit 200 transports a sheet while sandwiching the same between intermediate transfer belt 305 and secondary transfer roller 309. The toner image formed on intermediate transfer belt 305 is collectively transferred onto the sheet SH by secondary transfer roller 309. The sheet with the toner image formed thereon is fed to fixing device 400. The toner remaining on intermediate transfer belt 305 after the secondary transfer is removed from the surface of intermediate transfer belt 305 by a cleaning blade 306, transported by a conveyor screw (not shown), and collected in a waste toner container (not shown).

Control unit 500 is responsible for overall control of color printer 1000. Control unit 500 transmits a signal corresponding to an image to exposure controller 303.

Fixing device 400 transports a sheet, while sandwiching it, and applies heat and pressure to the sheet. In this manner, fixing device 400 melts the toner adhering to the sheet and fixes it on the sheet, thereby forming an image on the sheet.

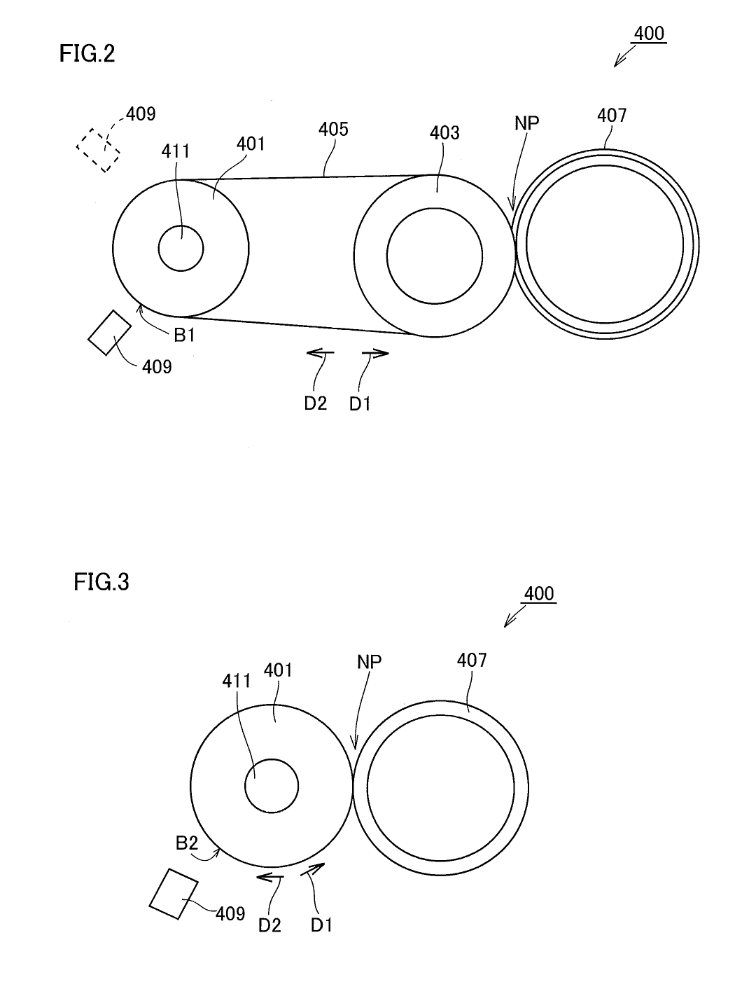

FIG. 2 is a cross sectional view schematically showing a configuration of the fixing device shown in FIG. 1. While FIG. 1 shows fixing device 400 such that a sheet passes through fixing device 400 leftward in the figure, FIGS. 2 and 3 each show fixing device 400 such that a sheet passes through fixing device 400 upward in the figure.

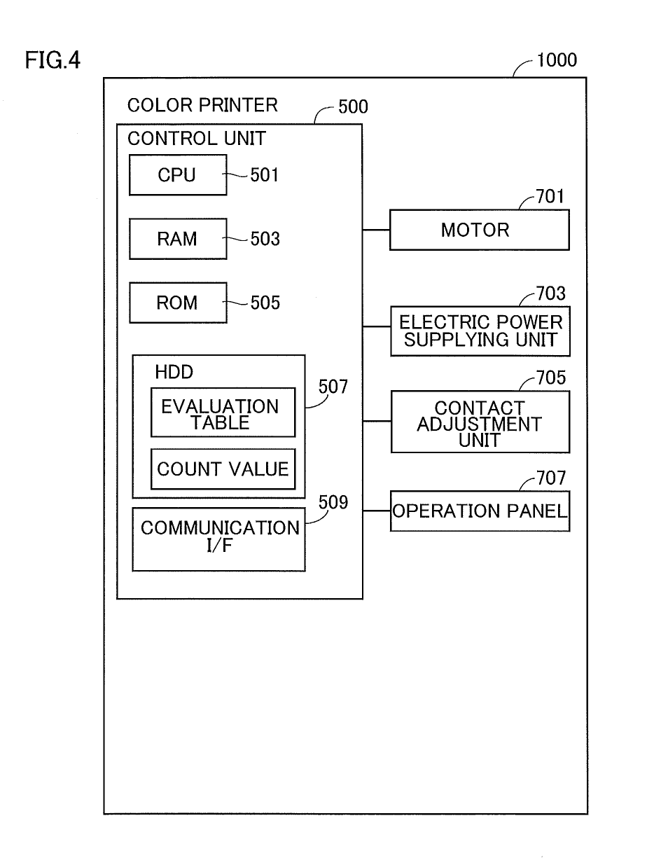

Referring to FIG. 2, fixing device 400 includes: a heating roller 401, a fixing roller 403, a fixing belt 405, a pressure roller 407 (an example of a pressure applying rotary body), a thermopile 409 (an example of a temperature measuring unit), and a heater 411 (an example of a heat source). Heating roller 401, fixing roller 403, fixing belt 405, and heater 411 constitute a heat applying rotary body. Heater 411 is built in heating roller 401. Heater 411 turns on as electric power is supplied thereto, for example, and heats heating roller 401. Fixing roller 403 is provided between heating roller 401 and pressure roller 407. Fixing belt 405 is looped around heating roller 401 and fixing roller 403. Pressure roller 407 is rotatably driven by a motor 701 (FIG. 4), and comes into contact with that portion of fixing belt 405 which is wound around fixing roller 403, to thereby form a nip portion NP.

Fixing device 400 is configured such that the pressure applying rotary body and the heat applying rotary body form a nip portion NP for sandwiching and transporting a sheet having a toner image (unfixed image) formed thereon. While transporting the sheet, fixing device 400 heats and presses the sheet with fixing belt 405 and pressure roller 407 so as to cause the toner image formed on the sheet to be fixed on the sheet. Thermopile 409 measures the temperature at a measurement location B1. The measurement location B1 is, for example, on a surface of that portion of fixing belt 405 which is wound around heating roller 401, and is located upstream of the nip portion NP (when the starting point is set at heating roller 401) in the rotational direction (shown by an arrow D1 in FIG. 2) of heating roller 401 at the time of fixing. Further, the measurement location B1 is, for example, on the downstream side of that portion of fixing belt 405 wound around heating roller 401.

Sizes and materials of the components of fixing device 400 are for example as follows. Heating roller 401 has an outer diameter of 25 mm and is about 330 mm long in the nip longitudinal direction. Heating roller 401 has a 0.6 mm-thick hollow core made of aluminum and a 15 μm-thick PTFE (polytetrafluoroethylene) coating which covers the core. Fixing roller 403 has an outer diameter of 30 mm, and has a 22 mm-diameter solid core made of iron, a 4 mm-thick rubber which covers the core, and a 2 mm-thick sponge which covers the rubber. Fixing belt 405 has an outer diameter of 60 mm, and has a 70 μm-thick polyimide, a 200 μm-thick rubber which covers the polyimide, and a 30 μm-thick PFA (polyfluoroalkoxy) which covers the rubber. Pressure roller 407 has an outer diameter of 35 mm, and has a 2 mm-thick core made of aluminum, a 2 mm-thick rubber which covers the core, and a 30 μm-thick PFA which covers the rubber. Heater 411 is a 999 W halogen lamp heater having a 290 mm luminous length. Thermopile 409 is arranged in non-contact with fixing belt 405 and 40 mm away from the paper feeding reference at the center. In this configuration, the heat capacity C1 as a sum of those of heating roller 401 and fixing belt 405 is smaller than the heat capacity C2 of pressure roller 407.

An operation of fixing device 400, following the turn-on of color printer 1000, to cause the surfaces of fixing belt 405 and pressure roller 407 to attain a ready temperature (a temperature at which printing is possible, a print-enabling temperature) is called a “warm-up operation”, and the time required for the warm-up operation is called “warm-up time”. Fixing device 400 also performs the warm-up operation when color printer 1000 is turned on again after being turned off, when it recovers from a paper jam, when the cover of color printer 1000 is closed, and when it wakes up from a sleep mode.

During the warm-up operation, electric power is supplied to heater 411 to turn it on, which in turn heats heating roller 401. At this time, motor 701 transmits driving force to a drive gear to rotate pressure roller 407, and cause heating roller 401, fixing roller 403, and fixing belt 405 to be driven to rotate by pressure roller 407. As a result, the heat of heating roller 401 is transmitted to the surface of fixing belt 405. When pressure roller 407 is at a high temperature, the heat of each of heating roller 401 and pressure roller 407 is transmitted to fixing belt 405. The turning on of heater 411 and the rotation of pressure roller 407 as described above cause an increase in surface temperature of fixing belt 405 and pressure roller 407.

Once the temperature measured by thermopile 409 has reached a predetermined ready temperature, fixing device 400 attains a ready state and sets a ready flag, indicating that fixing device 400 is at a temperature (ready temperature) at which printing is possible. While in the ready state, fixing device 400 enters a print standby state when no print signal is applied from control unit 500, which will be described later. During the print standby state, generally, the rotation of pressure roller 407 is stopped, and heater 411 is controlled to turn on/off such that the temperature measured by thermopile 409 is at a certain level (hereinafter, this temperature will be called the “target temperature”). On the other hand, when a print signal is applied from control unit 500, fixing device 400 starts a print operation. During the print operation, pressure roller 407 is rotated before a sheet (recording material) enters fixing device 400, to transmit the heat of heating roller 401 to the surfaces of fixing belt 405 and pressure roller 407 (if pressure roller 407 is at a high temperature, the heat of each of heating roller 401 and pressure roller 407 is transmitted to fixing belt 405). This increases the surface temperatures of fixing belt 405 and pressure roller 407.

It is noted that the fixing device is not limited to the one of a belt fixing type in which a fixing belt and a pressure roller form a nip portion, as shown in FIG. 2. The fixing device may be, for example, of a roller fixing type in which a heating roller and a pressure roller form the nip portion, as shown in FIG. 3, which will now be described.

FIG. 3 is a cross sectional view schematically showing another configuration of the fixing device shown in FIG. 1.

Referring to FIG. 3, a fixing device 400 includes: a heating roller 401 (an example of a heat applying rotary body); a pressure roller 407 (an example of a pressure applying rotary body); a thermopile 409 (an example of a temperature measuring unit); and a heater 411. Heater 411 is built in heating roller 401. Pressure roller 407 comes into contact with heating roller 401 to form a nip portion NP. Thermopile 409 measure the temperature at a measurement location B2. The measurement location B2 is, for example, on the surface of a portion of heating roller 401, and is located upstream of the nip portion NP in the rotational direction (shown by an arrow D1 in FIG. 3) of heating roller 401 at the time of fixing. The measurement location B2 may be located, for example, downstream of the nip portion NP in the rotational direction of heating roller 401 at the time of fixing.

During the warm-up operation of this fixing device 400, electric power is supplied to heater 411 to turn it on, which in turn heats heating roller 401. At this time, a motor 701 transmits driving force to a drive gear to rotate heating roller 401, and cause pressure roller 407 to be driven to rotate by heating roller 401. As a result, the heat of heating roller 401 is transmitted to pressure roller 407. The turning on of heater 411 and the rotation of pressure roller 407 as described above cause an increase in surface temperature of heating roller 401 and pressure roller 407.

The other configuration and operation of the fixing device are identical to those of the fixing device shown in FIG. 2, and thus, the same members are denoted by the same reference characters, and a description thereof will not be repeated.

FIG. 4 is a block diagram showing the configuration of the color printer according to an embodiment of the present invention.

Referring to FIG. 4, a control unit 500 in color printer 1000 includes, for example, a central processing unit (CPU) 501, a random access memory (RAM) 503, a read only memory (ROM) 505, a hard disk drive (HDD) 507 as a storage device, and a communication interface (I/F) 509. Color printer 1000 further includes a motor 701, an electric power supplying unit 703, a contact adjustment unit 705 (pressing/separating mechanism), and an operation panel 707. Motor 701, electric power supplying unit 703, contact adjustment unit 705, and operation panel 707 are each connected to control unit 500.

CPU 501 is responsible for overall control of color printer 1000. CPU 501 executes a control program stored in ROM 505. CPU 501 performs prescribed processing to read data from and write data to RAM 503 and ROM 505. CPU 501 controls an output of motor 701 to thereby control the rotation of pressure roller 407. CPU 501 adjusts the amount of electric power supply from electric power supplying unit 703 to thereby control heater 411. Furthermore, CPU 501, through the intermediary of contact adjustment unit 705, adjusts the pressure-contact state between fixing belt 405 and pressure roller 407 (or between heating roller 401 and pressure roller 407 in the fixing device shown in FIG. 3).

RAM 503 is a main memory for CPU 501. RAM 503 is used, for example, for storing data necessary for CPU 501 to execute the control program.

ROM 505 may be, for example, a flash ROM (flash memory). ROM 505 stores various programs for an operation of color printer 1000 as well as various fixed data. ROM 505 may be non-rewritable.

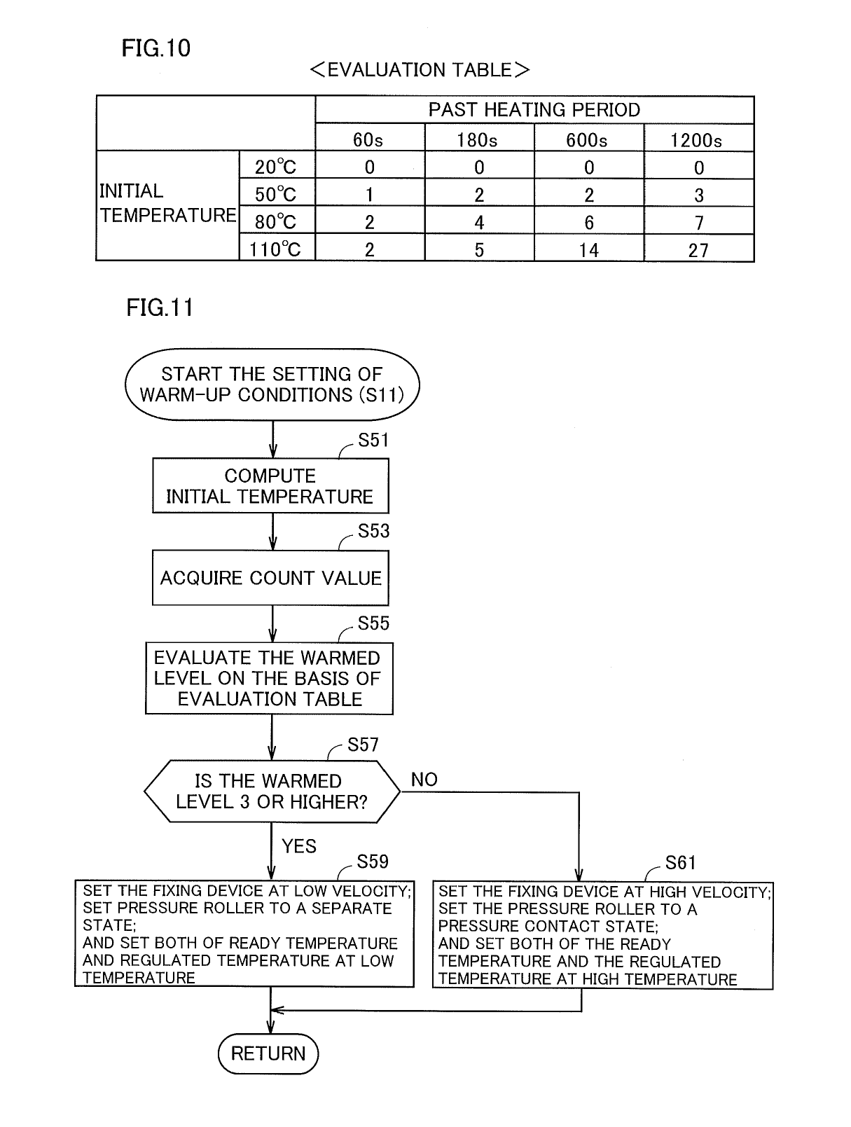

HDD 507 is a storage device which stores data such as print data transmitted from the outside via communication I/F 509. Further, HDD 507 stores an evaluation table (FIG. 10), which will be described later, and also constitutes a backup area of count values, which will be described later.

Communication I/F 509, in accordance with an instruction from CPU 501, communicates with an external device via a LAN, for example, by using a communication protocol such as TCP/IP.

Operation panel 707 includes a key input unit (not shown) composed of a ten key pad, a start key, and so on, and a display unit (not shown) composed of a liquid crystal touch panel or the like. Operation panel 707 is used by a user to perform various operations.

### [Warm-Up Operation of Fixing Device]

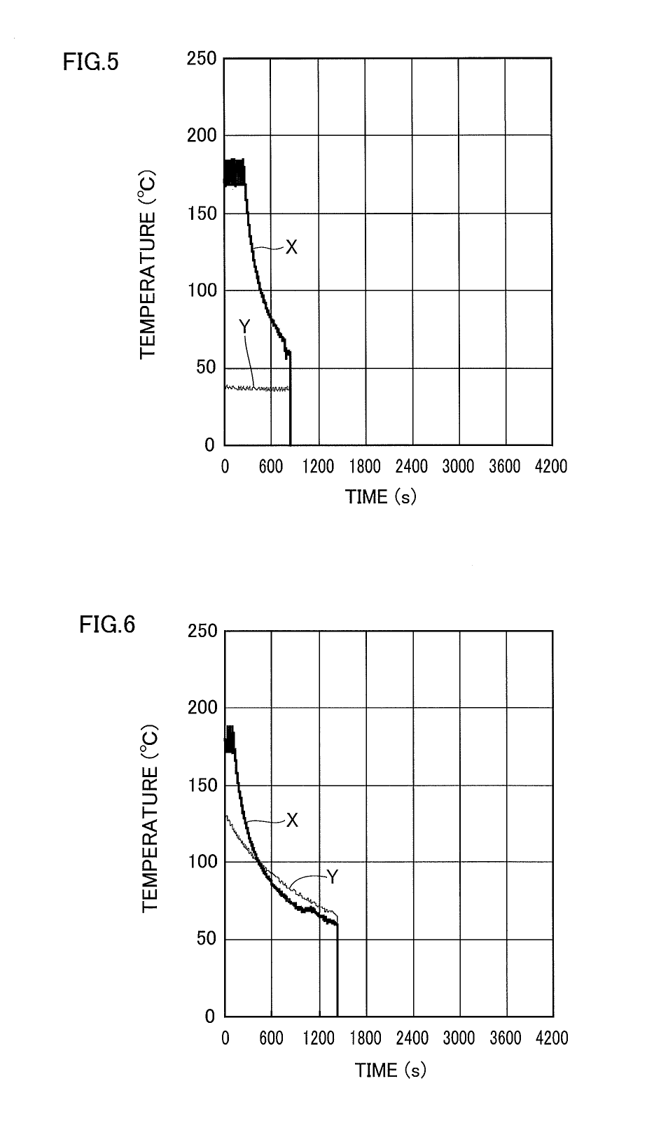

FIGS. 5 and 6 show temperature changes over time of heating and pressure rollers when a heater is turned off while it is at the target temperature. FIG. 5 shows the case where the pressure roller is at a low temperature when the heater is turned off, whereas FIG. 6 shows the case where the pressure roller is at a high temperature when the heater is turned off. In FIGS. 5 and 6, the temperatures of the heating roller and the pressure roller are denoted by X and Y, respectively.

Referring to FIGS. 5 and 6, the temperature X of heating roller 401 decreases gradually over time in both cases. In the case where pressure roller 407 is at a low temperature when heater 411 is turned off (FIG. 5), the temperature Y of pressure roller 407 is always lower than the temperature X of heating roller 401. On the other hand, in the case where pressure roller 407 is at a high temperature when heater 411 is turned off (FIG. 6), the temperature Y of pressure roller 407 temporarily exceeds the temperature X of heating roller 401. More specifically, in FIG. 6, after 500 seconds have passed since heater 411 was turned off (i.e., after the temperatures of heating roller 401 and pressure roller 407 have lowered to about 100° C.), the temperature Y of pressure roller 407 becomes higher than the temperature X of heating roller 401. This is because the heat capacity C1 as a sum of those of heating roller 401 and fixing belt 405 is smaller than the heat capacity C2 of pressure roller 407.

That is, as pressure roller 407 has relatively large heat capacity, the temperature of pressure roller 407 at the start of the warm-up operation will vary depending on, for example, how and to what extent pressure roller 407 has been heated prior to the warm-up operation. Thus, fixing device 400 uses thermopile 409 to estimate the temperature of pressure roller 407, and controls the warm-up operation in accordance with the estimated temperature.

The temperature of pressure roller 407 may be estimated for example in the following manner. In fixing device 400 shown in FIG. 2, pressure roller 407 is rotated to cause that portion of fixing belt 405 which was located at the nip portion NP to move to the measurement location B1, and a temperature T2 of that portion is measured by thermopile 409. The temperature T2 thus measured is used as the estimated temperature of pressure roller 407.

Here, heater 411 may be turned on before the estimation of the temperature of pressure roller 407, so that the warm-up time may be reduced. In this case, it is preferable to cause fixing belt 405 to move in the direction shown by an arrow D2 in FIG. 2, so that the portion of fixing belt 405 which was located at the nip portion NP will not pass by heating roller 401 as it moves to the measurement location B1. The direction shown by the arrow D2 is opposite from the rotational direction (shown by the arrow D1 in FIG. 2) of fixing belt 405 at the time of fixing. This can prevent the measured temperature T2 from becoming higher than the actual temperature of pressure roller 407 due to the heat otherwise provided from heating roller 401.

It is noted that thermopile 409 may be arranged at the position indicated by a broken line in FIG. 2 (in the case where the measurement location is on the upstream side of that portion of fixing belt 405 which is wound around heating roller 401). In this case, fixing belt 405 may be moved in the direction shown by the arrow D1 in FIG. 2, which can similarly prevent the effect of the heat from heating roller 401.

Further, thermopile 409 may measure a temperature T1 of that portion on the surface of fixing belt 405 which is located at the measurement location B1 at the start of the warm-up operation (or, before the portion of fixing belt 405 located at the nip portion NP is moved to the measurement location B1). In this case, the warm-up operation can be controlled on the basis of the temperatures T1 and T2.

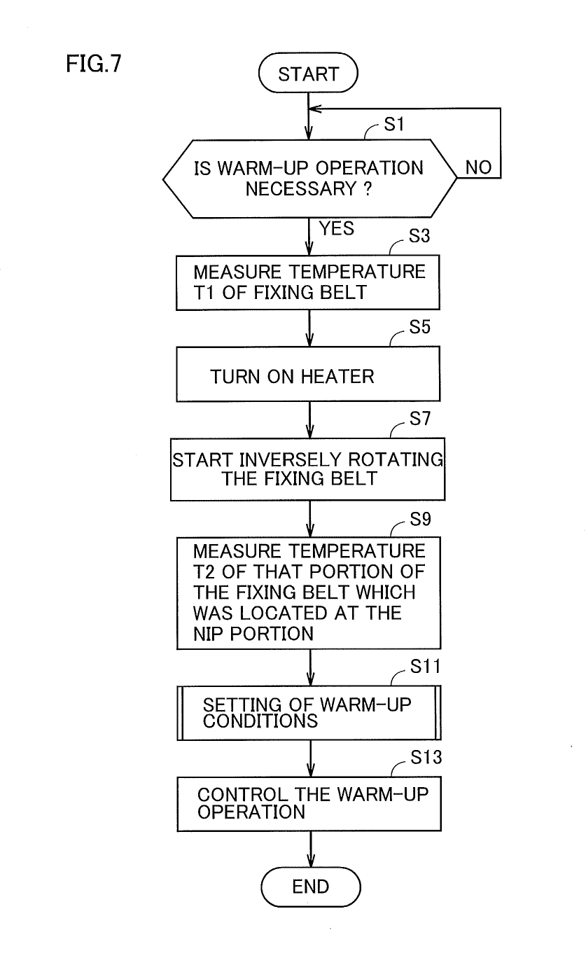

FIG. 7 is a flowchart illustrating the warm-up operation of the fixing device.

Referring to FIG. 7, in the case where the warm-up operation is necessary (YES in S1), CPU 501 uses thermopile 409 to measure the temperature T1 of that portion on the surface of fixing belt 405 which is located at the measurement location B1 (S3). It is preferable that the temperature T1 is measured before heater 411 is turned on (in step S5), in consideration of the effect of the heat from heater 411. Next, CPU 501 turns on heater 411 by supplying electric power from electric power supplying unit 703 to heater 411 (S5). In the state where heater 411 is on, CPU 501 uses motor 701 to inversely rotate pressure roller 407, so that fixing belt 405 is rotated inversely in the direction shown by the arrow D2 in FIG. 2 (S7). In this manner, the portion on the surface of fixing belt 405 which was located at the nip portion NP moves toward the measurement location B1. When the portion on the surface of fixing belt 405 which was located at the nip portion NP has reached the measurement location B1, CPU 501 uses thermopile 409 to measure the temperature T2 of that portion (S9). CPU 501 then sets warm-up conditions on the basis of the measured temperatures T1 and T2 (S11), and controls the warm-up operation in accordance with the set conditions (S13). The process is then terminated.

In the above flowchart, measurement of the temperature T1 may be omitted, in which case the warm-up operation is controlled on the basis of the temperature T2 alone. Further, the rotation of fixing belt 405 may be returned to the positive rotation (in the direction shown by the arrow D1 in FIG. 2) when the warm-up operation is controlled in step S13, or when the temperature measured by thermopile 409 has reached a ready temperature as a result of the warm-up operation.

### [Method for Setting Warm-Up Conditions of Fixing Device]

Now, as a specific way of setting the warm-up conditions in step S11 in FIG. 7, first and second setting methods will be described.

According to the first setting method, the warm-up conditions are set according to whether the temperatures T1 and T2 satisfy a prescribed expression, or more specifically, the following expression (1):

T1≧T2 (1)

The temperatures T1 and T2 satisfy the expression (1) in the case where fixing device 400 is not warm (i.e. the pressure roller is at a low temperature), as typically shown in FIG. 5. In this case, the warm-up operation is carried out in a normal operation. As the warm-up conditions in the normal operation, for example, the velocity (linear velocity) of the fixing device is set to 100 m/s, fixing roller 403 and pressure roller 407 are brought into a pressure contact state, the target temperature of fixing device 400 is set to 185° C., and the ready temperature is set to 165° C. These settings enable the heat to be supplied efficiently from heater 411 to pressure roller 407, which is not warm, so that fixing device 400 is heated rapidly.

On the other hand, the temperatures T1 and T2 fail to satisfy the expression (1) (i.e. T1<T2) in the case where fixing device 400 is warm (i.e. the pressure roller is at a high temperature), as typically shown in FIG. 6. In this case, compared to the case where fixing device 400 is cool, the velocity (linear velocity) of the fixing device is set slower than in the normal operation, the nip width of the nip portion NP between fixing roller 403 and pressure roller 407 is set smaller than in the normal operation (with a smaller contact pressure; for example, a separate state), the target temperature of fixing device 400 is set lower than in the normal operation, and the ready temperature is set lower than in the normal operation. It is noted that not all these warm-up conditions have to be set; at least one of these conditions may be set. As the exemplary conditions to be set, for example, the velocity (linear velocity) of the fixing device is set to 50 m/s, fixing roller 403 and pressure roller 407 are brought into a separate state, the target temperature of fixing device 400 is set to 180° C., and the ready temperature is set to 175° C.

In the state where fixing device 400 is warm, setting the velocity of fixing device 400 lower and the nip width at the nip portion NP smaller than in the normal operation can reduce the transmission of the heat to pressure roller 407 which is at a high temperature. The heat can be retained at each of heating roller 401, fixing roller 403, and fixing belt 405 which are at a low temperature, and accordingly, fixing device 400 can be heated rapidly. Further, setting the ready temperature lower than in the normal operation is advantageous in that, at the time of accelerating fixing device 400 to the velocity in the normal state for performing printing after fixing device 400 attains the ready state (warmed-up state), it is possible to address the event that the temperature on the fixing belt 405 side drops steeply as the heat is rapidly taken away to the pressure roller 407 side. In the state where fixing device 400 is warm, less heat transfers to the interior of pressure roller 407 and fixing roller 403 at the nip portion NP, allowing the heat to readily be transmitted to the sheet and toner. For this reason, the target temperature of fixing device 400 is set lower than in the normal operation.

In the first setting method, different expressions may be used in accordance with the temperature T1. For example, in the case where the temperature T1 is lower than 100° C., the warm-up conditions may be set according to whether the expression (1) is satisfied. In the case where the temperature T1 is not lower than 100° C., the warm-up conditions may be set according to whether the following expression (2) is satisfied:

T1−T2≧a (2)

where “a” may be a constant or a variable (preferably, a positive value) that may change in accordance with the value of the temperature T1 (the amount of temperature drop of heating roller 401).

In the case where the temperatures T1 and T2 satisfy the above expression (2), it is determined that fixing device 400 is not warm. In the case where the temperatures T1 and T2 do not satisfy the above expression (2), it is determined that fixing device 400 is warm.

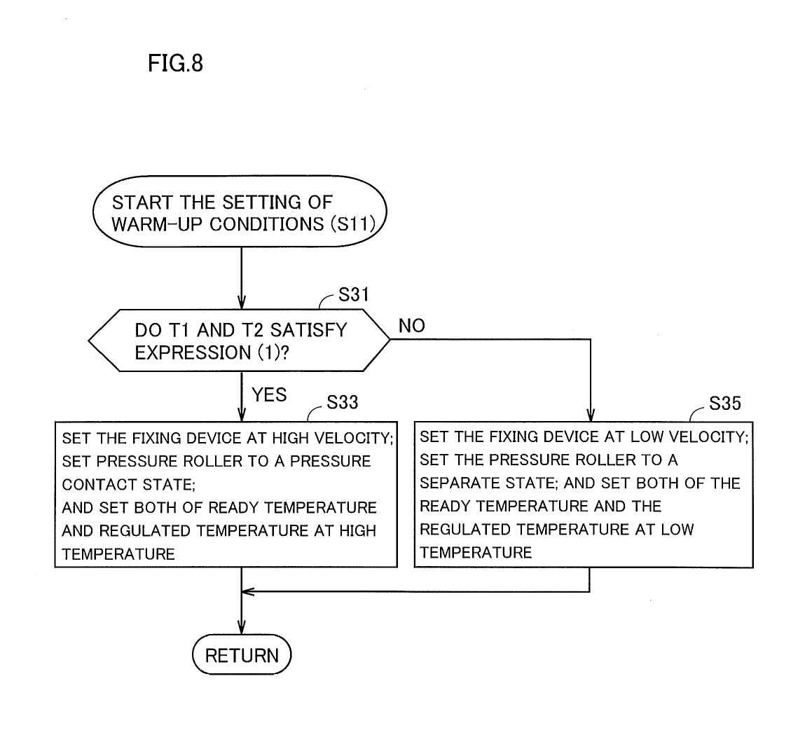

FIG. 8 illustrates a subroutine of the processing in step S11 in FIG. 7 in the case where the first setting method is employed.

Referring to FIG. 8, CPU 501 determines whether the temperatures T1 and T2 satisfy the expression (1) (S31). If it is determined in step S31 that the temperatures T1 and T2 satisfy the expression (1) (YES in S31), CPU 501 sets fixing device 400 (pressure roller 407) at a high speed, sets pressure roller 407 to a pressure contact state (with a large nip width), and sets both of the ready temperature and target temperature to high temperature (S33), before returning to the main routine. On the other hand, if it is determined in step S31 that the temperatures T1 and T2 do not satisfy the expression (1) (NO in S31), CPU 501 sets pressure roller 407 at a low speed, sets pressure roller 407 to a separate state (with a small nip width), and sets both of the ready temperature and target temperature to low temperature (S35), before returning to the main routine.

In the second setting method, a count value of at least a part of the control time of fixing device 400 is stored in a backup area in HDD 507, and the warm-up operation is controlled on the basis of the count value read from the backup area as well as the temperatures T1 and T2. First, the way of counting the control time of fixing device 400, carried out in the second setting method, will be described.

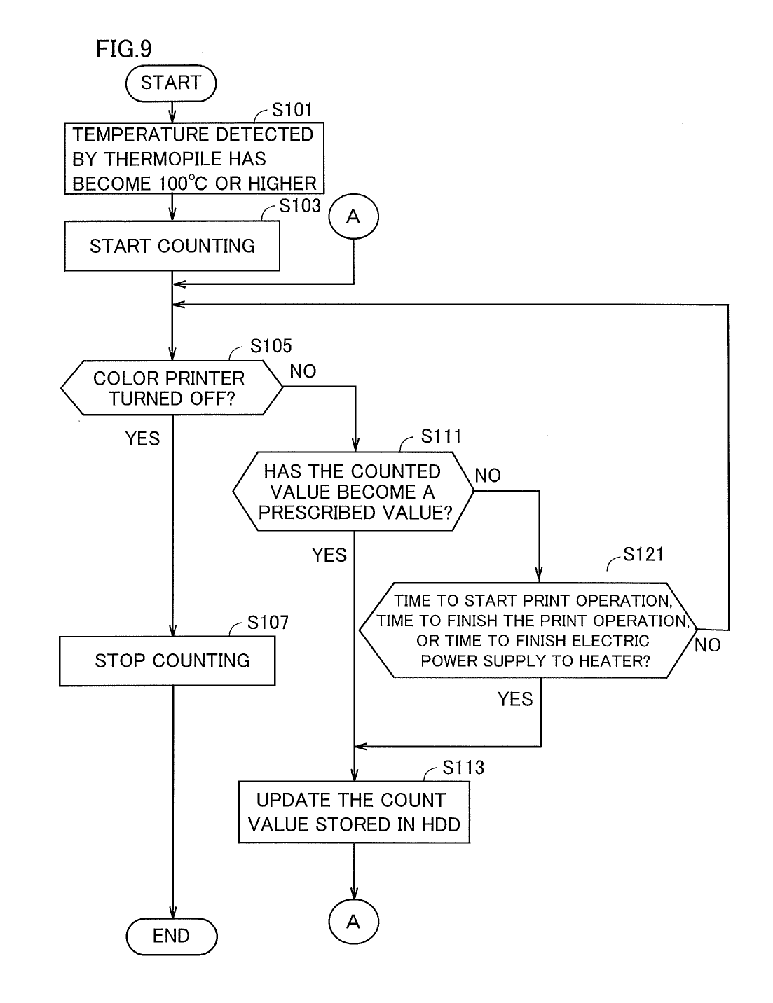

FIG. 9 is a flowchart illustrating a counting method of the fixing device which is carried out in the second setting method.

Referring to FIG. 9, when the temperature detected (measured) by thermopile 409 becomes, for example, 100° C. or higher (S101), CPU 501 starts counting time (S103). Next, CPU 501 determines whether color printer 1000 has been turned off (S105). If it is determined in step S105 that color printer 1000 has been turned off (YES in S105), CPU 501 stops counting (S107), and the process is terminated.

If it is determined in step S105 that color printer 1000 has not been turned off (NO in S105), CPU 501 determines whether the counted value has reached a prescribed value (for example, 60 seconds, 180 seconds, 600 seconds, or 1200 seconds) (S111). If it is determined in step S111 that the counted value has reached a prescribed value (YES in S111), CPU 501 stores the count value at that time in the backup area in HDD 507, to thereby update the count value stored in the backup area (S113). The process then proceeds to step S105.

If it is determined in step S111 that the count value has not reached a prescribed value (NO in S111), CPU 501 determines whether it is time to start a print operation, whether it is time to finish the print operation, or whether it is time to stop supplying electric power to heater 411 (S121). In step S121, it may be determined whether at least one of the above conditions has been satisfied. If it is determined in step S121 that it is time to start the print operation, or it is time to finish the print operation, or it is time to stop supplying electric power to heater 411 (YES in S121), CPU 501 proceeds to the processing in step S113. On the other hand, if it is determined in step S121 that it is not time to start the print operation, or time to finish the print operation, or time to stop supplying electric power to heater 411 (NO in S121), CPU 501 proceeds to the processing in step S105 while continuing the counting.

In the counting method described above, the control time is counted from zero when the temperature detected by thermopile 409 has reached 100° C. after the warm-up operation was started. The counting is continued steadily during the warm-up operation, during the standby state, and during the print operation. The count value is stored in the backup area in the device at the time when the count value has reached a prescribed value, or at the timing of state transition.

it is noted that the counting may be carried out in a way other than that described above. For example, the time from the start to the end of electric power supply to heater 411 (i.e. the time during which heater 411 is on) may be counted, or the time during which the detected (measured) temperature of heating roller 401 is higher than a specific temperature may be counted.

In the second setting method, the count value (backup value) stored in the backup area at the start of the warm-up operation is read, and the warmed level of fixing device 400 is evaluated on the basis of the read count value and the temperatures T1 and T2 by using an evaluation table shown in FIG. 10, for example. Then, the warm-up conditions are set on the basis of the warmed level of fixing device 400 (using the warmed level as an input).

FIG. 10 shows, by way of example, an evaluation table used in the second setting method.

Referring to FIG. 10, the “past heating period” in the evaluation table is set from the read count value. If the read count value is not on the table (for example when the read count value is 200 seconds), the largest value (180 seconds) among the values that are smaller than the read count value, for example, is selected.

The “initial temperature” is set, for example, using the temperatures T1 and T2 and in accordance with the following expression (3):

Initial Temperature=T1+(T2−T1)×b (3)

where “b” is a coefficient, which may be a fixed value or may be variable in accordance with the value of the temperature T1.

The values 0 to 27 on the evaluation table represent the warmed levels of fixing device 400. The larger number indicates that fixing device 400 is warmed to a greater degree.

It is noted that, instead of setting the initial temperature using the expression (3), the temperature T1 as it is may be set as the initial temperature. Further, a plurality of evaluation tables may be stored in HDD 507, and the evaluation table to be used may be selected therefrom depending on the value of (T2−T1). Furthermore, a value for adjusting the warmed level in accordance with the value of (T2−T1) may be added to an evaluation table.

Further, in the second setting method, instead of using an evaluation table, the following expression (4), for example, may be used to evaluate the warmed level of fixing device 400:

Warmed Level=B×Count Value×(Initial Temperature−A) (4)

where “A” and “B” are coefficients, which may be fixed values or may be variable in accordance with the value of the temperature T1.

In the second setting method, if the value indicating the warmed level is less than 3, for example, it is determined that fixing device 400 is not warm. In this case, the warm-up operation is carried out in a normal operation. As the exemplary warm-up conditions in the normal operation, the velocity (linear velocity) of the fixing device is set to 100 m/s, fixing roller 403 and pressure roller 407 are brought into a pressure contact state, the target temperature of fixing device 400 is set to 185° C., and the ready temperature is set to 165° C.

On the other hand, if the value indicating the warmed level is 3 or more, for example, it is determined that fixing device 400 is warm. In this case, compared to the case where fixing device 400 is cool, the velocity (linear velocity) of the fixing device is set lower than in the normal operation, the nip width of the nip portion NP between fixing roller 403 and pressure roller 407 is set smaller than in the normal operation (for example, a separate state), the target temperature of fixing device 400 is set lower than in the normal operation, and the ready temperature is set lower than in the normal operation. It is noted that not all these warm-up conditions have to be set; at least one of these conditions may be set. As the exemplary conditions to be set, the velocity (linear velocity) of the fixing device is set to 50 m/s, fixing roller 403 and pressure roller 407 are brought into a separate state, the target temperature of fixing device 400 is set to 180° C., and the ready temperature is set to 175° C.

FIG. 11 illustrates a subroutine of the processing in step S11 in FIG. 7 in the case where the second setting method is employed.

Referring to FIG. 11, CPU 501 uses the above expression (3), for example, to compute the initial temperature on the basis of the temperatures T1 and T2 (S51). CPU 501 then acquires (reads) a count value from HDD 507 (S53), and evaluates the warmed level of fixing device 400 on the basis of the initial temperature and the acquired count value, by using an evaluation table stored in HDD 507 (S55). CPU 501 then determines whether the value of the evaluated warmed level of fixing device 400 is 3 or more (S57).

If it is determined in step S57 that the value of the evaluated warmed level of fixing device 400 is 3 or more (YES in S57), CPU 501 sets fixing device 400 at a low speed, sets pressure roller 407 to a separate state (with a smaller nip width), and sets the ready temperature and the target temperature to low temperature (S59), before returning to the main routine. On the other hand, if it is determined in step S57 that the value of the evaluated warmed level of fixing device 400 is less than 3 (NO in S57), CPU 501 sets fixing device 400 at a high speed, sets pressure roller 407 to a pressure contact state (with a greater nip width), and sets the ready temperature and the target temperature to high temperature (S61), before returning to the main routine.

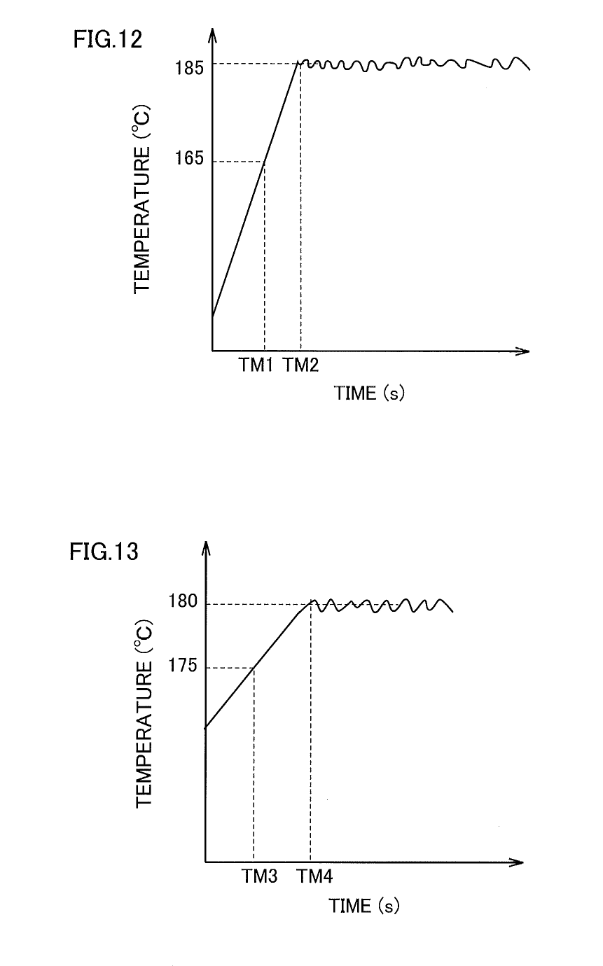

FIGS. 12 and 13 schematically show changes over time of the temperature of the pressure roller during the warm-up operation. FIG. 12 corresponds to the case where the pressure roller (fixing device) is not warm, while FIG. 13 corresponds to the case where the pressure roller (fixing device) is warm.

Referring to FIG. 12, in the case where pressure roller 407 is not warm at the start of the warm-up operation, the warm-up operation is controlled such that the heat of heater 411 is efficiently transmitted to pressure roller 407, and accordingly, the temperature of the pressure roller increases steeply. When the ready temperature (165° C.) is reached at time TM1, the print operation is started. The target temperature (185° C.) is reached at time TM2 when a first sheet of paper passes through the fixing device.

Referring to FIG. 13, in the case where pressure roller 407 is warm at the start of the warm-up operation, the warm-up operation is controlled such that the heat is retained at heating roller 401, fixing roller 403, and fixing belt 405, and that the smallest possible amount of heat is transmitted to pressure roller 407. As a result, the temperature of pressure roller 407 increases gradually together with the temperatures of heating roller 401, fixing roller 403, and fixing belt 405. The print operation is started at time TM3 when the ready temperature (175° C.) is reached. Then, at time TM4 when a first sheet of paper passes through the fixing device, the target temperature (180° C.) is reached. As a result, it is possible to minimize the time [s] for supplying electric power [W] of the amount necessary for the warm-up operation of fixing device 400.

### EFFECTS OF THE EMBODIMENT

Fixing device 400 and color printer 1000 equipped with the same in the present embodiment are configured to calculate the overall storage of heat in fixing device 400 at the time of return operation from a sleep mode or the like, on the basis of the temperatures T1 and T2 (start temperatures) and the past control history, to thereby perform an optimal warm-up operation in accordance with the storage of heat.

According to fixing device 400 and color printer 1000 equipped with the same in the present embodiment, the temperature T2 of that portion on the surface of fixing belt 405 which was located at the nip portion NP with pressure roller 407 at the start of the warm-up operation is measured to estimate the temperature of pressure roller 407, and the warm-up operation is controlled in accordance with the estimated temperature of pressure roller 407. This ensures that the heat being retained in fixing device 400 (the heat retaining state of fixing device 400) at the start of the warm-up operation is calculated with accuracy. It is known in advance what amount of heat is required for which part in order to satisfy a desired fix level. Thus, an optimal way of inputting the heat can be selected on the basis of the measured temperature. As a result, the time required for the return operation can be reduced, and the user's wait time for the device to wake up from the sleep mode can be shortened. Furthermore, wasteful heat consumption and, hence, electric power consumption can be reduced.

Particularly in the case where the second setting method is adopted, the heat stored in fixing device 400 can be calculated and the warmed level of fixing device 400 can be estimated more accurately on the basis of the past heating history and the temperatures T1 and T2 at present. The startup method thereafter can then be changed by using the estimated warmed level as an input, so that the return time can be reduced.

According to the above embodiment, it is possible to provide a fixing device capable of reducing the time required for a warm-up operation, an image forming device and a method and program for controlling the fixing device. Further, according to the above embodiment, it is possible to provide a fixing device capable of reducing electric power consumption, an image forming device, and a method and program for controlling the fixing device.

### Others

As the temperature measuring unit for measuring the surface temperature of the heat applying rotary body, a thermistor or a thermocouple, for example, may be used in place of the thermopile. As the heat source, a resistance heating element or an induction heating (IH) apparatus may be used in place of the heater. Furthermore, the heat source is not restricted to the one that heats the heat applying rotary body from inside, as in the above-described embodiment; it may be the one that heats the heat applying rotary body from outside.

The motor may be configured to give driving force to the heat applying rotary body instead of or in addition to, giving driving force to the pressure applying rotary body.

The conditions and settings of the fixing device in the above embodiment are only illustrative; other conditions and settings may be adopted instead.

The features of the embodiment described above may be combined as appropriate. For example, the fixing device having the configuration shown in FIG. 4 may adopt the second setting method described above.

The processes according to the above embodiment may be performed by software or by using a hardware circuit.

A program for executing the processes according to the above embodiment may be provided as well. The program may be recorded on a recording medium, such as a CD-ROM, flexible disk, hard disk, ROM, RAM, memory card, or the like, so as to be provided to a user. The program is executed by a computer such as a CPU. The program may also be downloaded to the device via a communication line such as the Internet.

Although the preset invention has been described and illustrated in detail, it is clearly understood that the same is by way of illustration and example only and is not to be taken by way of limitation, the spirit and scope of the present invention being limited only by the terms of the appended claims.

What is claimed is:

1. A fixing device comprising a heat applying rotary body heated by a heat source, a pressure applying rotary body which comes into contact with said heat applying rotary body to form a nip portion, and a temperature measuring unit capable of measuring a temperature of a surface of said heat applying rotary body, the fixing device further comprising:
a moving unit operable to move that portion on the surface of said heat applying rotary body which was located at said nip portion at the start of a warm-up operation to a measurement location of said temperature measuring unit, the warm-up operation being an operation of bringing surfaces of said heat applying rotary body and said pressure applying rotary body to a temperature at which printing is possible;
a first temperature measuring unit that uses said temperature measuring unit to measure a temperature of that portion on the surface of said heat applying rotary body moved to said measurement location by said moving unit; and
a warm-up control unit that controls said warm-up operation on the basis of the temperature measured by said first temperature measuring unit.

2. The fixing device according to claim 1, wherein
said measurement location is located upstream of said nip portion in a rotational direction of said heat applying rotary body at the time of fixing, and
said moving unit moves that portion on the surface of said heat applying rotary body which was located at said nip portion to said measurement location by rotating said heat applying rotary body in a direction opposite from the rotational direction at the time of fixing.

3. The fixing device according to claim 2, further comprising a heating unit that heats said heat source by supplying electric power to said heat source while said moving unit is rotating said heat applying rotary body in the direction opposite from the rotational direction at the time of fixing.

4. The fixing device according to claim 1, wherein
said heat applying rotary body includes a heating roller having said heat source built therein, a fixing roller arranged between said heating roller and said pressure applying rotary body, and a fixing belt looped around said heating roller and said fixing roller, and
said measurement location is located on a downstream side of that portion of said fixing belt which is wound around said heating roller in a rotational direction of said fixing belt at the time of fixing.

5. The fixing device according to claim 4, wherein heat capacity C1 as a sum of heat capacity of said heating roller and heat capacity of said fixing belt is smaller than heat capacity C2 of said pressure applying rotary body.

6. The fixing device according to claim 1, wherein said warm-up control unit controls at least one of a velocity of said fixing device, a pressure contact state between said heat applying rotary body and said pressure applying rotary body, a print-permitting temperature, and a target temperature of said fixing device.

7. The fixing device according to claim 1, further comprising a second temperature measuring unit that uses said temperature measuring unit to measure a temperature of that portion on the surface of said heat applying rotary body which is located at said measurement location at the start of said warm-up operation, wherein
said warm-up control unit controls said warm-up operation further on the basis of the temperature measured by said second temperature measuring unit.

8. The fixing device according to claim 1, further comprising:
a counting unit that counts at least a part of control time of said fixing device;
a storing unit that stores a value counted by said counting unit; and
a reading unit that reads the value stored in said storing unit; wherein
said warm-up control unit controls said warm-up operation further on the basis of the value read by said reading unit.

9. The fixing device according to claim 8, further comprising an evaluation unit that evaluates a warmed level of the fixing device on the basis of the temperature measured by said first temperature measuring unit and the value read by said reading unit, wherein
said warm-up control unit controls said warm-up operation on the basis of the warmed level evaluated by said evaluation unit.

10. The fixing device according to claim 8, wherein said counting unit counts time during which the temperature measured by said first temperature measuring unit is higher than a specific temperature.

11. The fixing device according to claim 8, wherein said counting unit counts time from a start to an end of electric power supply to said heat source.

12. The fixing device according to claim 8, wherein said storing unit stores the value counted by said counting unit each time the value counted by said counting unit becomes a prescribed value.

13. The fixing device according to claim 8, wherein said storing unit stores the value counted by said counting unit at least at one time selected from the group consisting of: a start of a print operation, an end of the print operation, and an end of electric power supply to said heat source.

14. The fixing device according to claim 1, wherein in the case where said fixing device is relatively warm, said warm-up control unit controls said warm-up operation in at least one manner selected from the group consisting of: reducing a velocity of said fixing device, reducing a nip width between said heat applying rotary body and said pressure applying rotary body, and lowering a target temperature of said fixing device, compared to the case where said fixing device is relatively cool.

15. The fixing device according to claim 14, wherein in the case where said fixing device is relatively warm, said warm-up control unit reduces the velocity of said fixing device and lowers a print-permitting temperature of said fixing device, compared to the case where said fixing device is relatively cool.

16. An image forming device comprising:
a toner image forming unit that forms a toner image on a sheet of paper; and
the fixing device according to claim 1, which fixes the toner image formed by said toner image forming unit on said sheet of paper.

17. A method for controlling a fixing device, the fixing device including a heat applying rotary body heated by a heat source, a pressure applying rotary body which comes into contact with said heat applying rotary body to form a nip portion, and a temperature measuring unit capable of measuring a temperature of a surface of said heat applying rotary body, the method comprising:
a moving step of moving that portion on the surface of said heat applying rotary body which was located at said nip portion at the start of a warm-up operation to a measurement location of said temperature measuring unit, the warm-up operation being an operation of bringing surfaces of said heat applying rotary body and said pressure applying rotary body to a temperature at which printing is possible;
a first temperature measuring step of measuring, using said temperature measuring unit, a temperature of that portion on the surface of said heat applying rotary body moved to said measurement location in said moving step; and
a warm-up control step of controlling said warm-up operation on the basis of the temperature measured in said first temperature measuring step.

18. A non-transitory computer-readable recording medium which stores a program for controlling a fixing device,
said fixing device including a heat applying rotary body heated by a heat source, a pressure applying rotary body which comes into contact with said heat applying rotary body to form a nip portion, and a temperature measuring unit capable of measuring a temperature of a surface of said heat applying rotary body,
the program for controlling said fixing device causing a computer to perform:
a moving step of moving that portion on the surface of said heat applying rotary body which was located at said nip portion at the start of a warm-up operation to a measurement location of said temperature measuring unit, the warm-up operation being an operation of bringing surfaces of said heat applying rotary body and said pressure applying rotary body to a temperature at which printing is possible;
a first temperature measuring step of measuring, using said temperature measuring unit, a temperature of that portion on the surface of said heat applying rotary body moved to said measurement location in said moving step; and
a warm-up control step of controlling said warm-up operation on the basis of the temperature measured in said first temperature measuring step.
